(19) United States
(12) Patent Application Publication
(10) Pub. No.: US 2009/0170580 A1
(43) Pub. Date: Jul. 2, 2009

(54) Method of playing a game

(76) Inventor: Bradley Emalfarb, Riverwoods, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/005,509

(22) Filed: Dec. 27, 2007

(51) Int. Cl. A63F 9/24; A63F 13/12

(52) U.S. Cl. 463/9; 463/48; 463/43; 463/42

(57) ABSTRACT

A method of playing a game including the steps of: providing a cache with a device through which an input can be made by a player to generate output information for the player; placing the cache at a first location; and identifying for a player general location information that will allow the player to navigate to a zone in the vicinity of the cache at the first location but that requires the player to search without the availability of precise location information within the zone to find the cache.

### BACKGROUND OF THE INVENTION

1. Field of the Invention

This invention relates to games, as participated in by use of electronic equipment and, more particularly, to a game that may be enhanced by the use of global positioning system (GPS) equipment.

### BACKGROUND ART

The proliferation of electronics continues on a worldwide basis. Purveyors of hardware and software are constantly seeking out new designs to increase customer interest and distinguish their company's products from those of their competitors.

One of the most intriguing product categories in this industry continues to be that which includes electronic games, in which users participate from early youth through adulthood. These games are available using many different platforms. Self-contained electronic games are still available but are being replaced more and more by games utilizing personal computers and compatible software and those available to be accessed through the Internet.

These games offer a wide range of user participation. Some are designed for pure entertainment, while others integrate educational aspects and challenge coordination and dexterity.

One thing most electronic games have in common is that they allow participation from a stationary position. This appears to have contributed largely to the obesity epidemic that is plaguing the worldwide population. Users of these types of electronic games may sit continuously for hours on end and be exposed to virtually a limitless number of different experiences. This is a problem not only with respect to use for pure entertainment purposes, but other types of use that may have a more educational or professional objective.

While the electronics industry has made available vast resources, unparalleled in terms of the their capabilities and variety, as noted above, this success has also contributed to user obesity, isolation, and general lethargy associated with physical inactivity.

While these problems are experienced at all ages, they are particularly troublesome from the standpoint of how they are affecting young users. Younger and younger children are becoming more and more prolific, and involved, with electronics that promote the above problems. The positive ends of data accessing, education, training and entertainment are offset by the greater potential for compromised physical and mental health. An industry that has the potential to increase learning and development may be leading to a detrimental cultural change that results in poorer social interaction and higher healthcare costs.

Those in the electronics industry must be ever cognizant of the potential downside of the bourgeoning electronics industry and develop products and technologies which are aimed at the total well being of users thereof. Towards this end, products that encourage physical activity and family and social interaction are highly desirable.

### SUMMARY OF THE INVENTION

The invention is directed to a method of playing a game. The method includes the steps of: providing a cache with a device through which an input can be made by a player to generate output information for the player; placing the cache at a first location; and identifying for a player general location information that will allow the player to navigate to a zone in the vicinity of the cache at the first location but that requires the player to search without the availability of precise location information within the zone to find the cache.

In one form, the method further includes the step of providing cache information to a player regarding the output information to entice a player to participate in the game.

In one form, the step of providing a cache involves providing a cache with an electronic device.

In one form, the step of identifying general location information involves identifying general location information from data that can be input to a piece of equipment capable of processing signals from global positioning system satellites to allow a player to navigate to the zone.

In one form, the step of placing the cache involves placing the cache at a first hidden location.

In one form, the step of placing the cache involves placing the cache at a first location that requires a player to navigate through/around impediments to reach the cache.

In one form, the step of placing the cache involves placing the cache at a first location that is outside of a building structure.

In one form, the step of providing a cache involves providing a cache with a device having a first electronic component.

In one form, the invention further includes the step of providing at least a second electronic component that is usable with the first electronic component.

In one form, the step of providing a cache involves providing a first electronic component with a processor that interacts with the second electronic component to generate the output information.

In one form, the step of providing a cache involves providing a first electronic component with a game processor.

The invention may further include the steps of at least one of: a) repositioning the electronic device from the first location; or b) providing a different electronic device to change the output information that can be generated by a player.

The method may further include the step of setting up a reporting system whereby a player can store output information.

In one form, the method further includes the step of setting up a reporting system whereby a player can compare output information with at least one of: a) output information generated by him/herself; and b) output information generated by another player.

In one form, the method includes the step of providing a piece of electronic equipment for use by a player, with the piece of electronic equipment being a combination of: a) an electronic component that can be processed by the device; and b) a global positioning system device through which signals from global positioning system satellites can be processed.

In one form, the step of identifying for a player general information involves identifying general information on an Internet site.

In one form, the method further includes the step of setting up at least one of: a) a set of rules; and b) a set of goals on an Internet site to allow competition with additional players.

In one form, the step of setting up at least one of a set of rules and a set of goals includes setting up at least one of a set of rules and a set of goals that have benchmarks requiring the performance of multiple tasks.

In one form, the step of setting up at least one of a set of rules and a set of goals includes setting up at least one of a set of rules and a set of goals that have benchmarks requiring the performance of multiple tasks that are at least one of: a) multiple trips to the first location and multiple interactions with the cache; and b) at least a second trip to at least one of: i) the first location; and ii) a second location at which a second cache is located and multiple interactions with the cache at the first location and/or second location.

In one form, the step of providing a cache involves providing a cache with a device having a first electronic component with a video display.

In another form, a method of playing a game includes the steps of: providing a cache with a device through which an input can be made by a player to generate output information for the player; placing the cache at a first location; and identifying for a player general location information that will allow the player to navigate to a zone in the vicinity of the cache at the first location using only data that can be input to a piece of equipment capable of processing signals from a global positioning system satellite.

In one form, the step of providing a cache involves providing a cache with an electronic device.

In one form, the step of providing a cache involves providing a cache with a device having a first electronic component.

In one form, the method includes the step of providing at least a second electronic component that is usable with the first electronic component.

In one form, the method includes the step of providing a cache having a first electronic component with a processor that interacts with the second electronic component to generate the output information.

### BRIEF DESCRIPTION OF THE DRAWINGS

FIG. 1 is a schematic representation of a conventional geocaching system;

FIG. 2 is a schematic representation of a geocaching system, according to the present invention, including a cache with an associated device with which a user can interact;

FIG. 3 is a block diagram representation of one method of playing a game, according to the present invention;

FIG. 4 is a schematic representation of one form of device on the cache and consisting of an electronic device with an input for a cooperating electronic component;

FIG. 5 is a schematic representation of another form of device and cooperating electronic component, according to the invention;

FIG. 6 is a schematic representation of a geocaching system including separate caches at spaced locations;

FIG. 7 is a schematic representation of one of the devices on the cache capable of generating output information that can be communicated and stored through the Internet;

FIG. 8 is a block diagram representation of another part of a method, according to the invention, for processing output information generated through the cache;

FIG. 9 is a block diagram representation of another method for processing output information in a gaming system format;

FIG. 10 is a block diagram representation of another method of playing a game, according to the invention; and

FIG. 11 is a schematic representation of an integrated piece of electronic equipment incorporating a GPS processing device and an electronic component for interacting with the device on the cache.

### DETAILED DESCRIPTION OF THE DRAWINGS

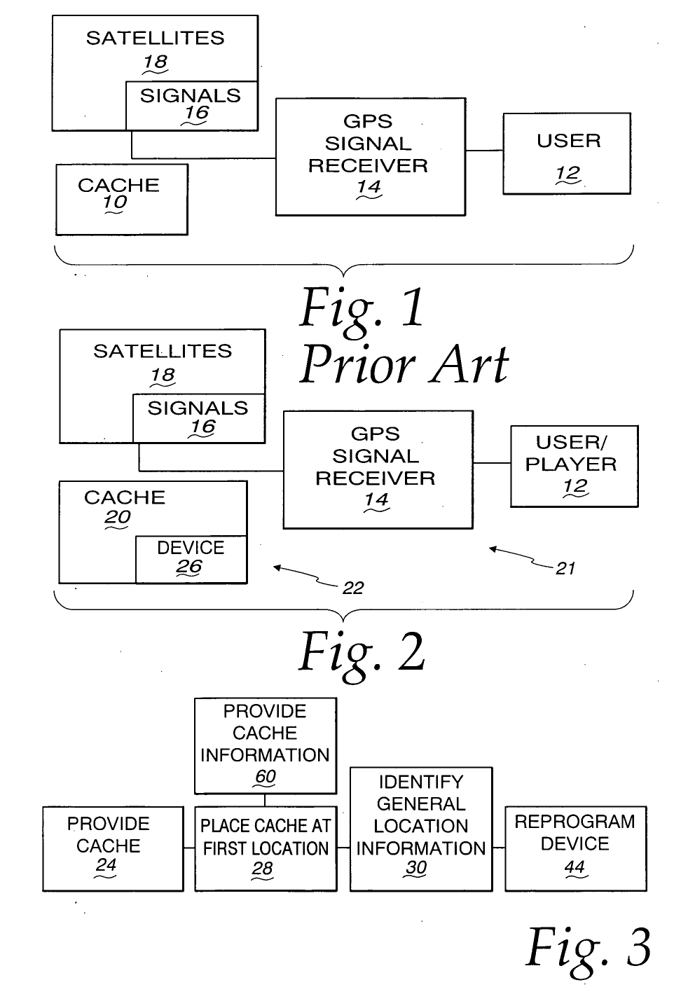

Geocaching is a modern day “treasure hunt” that utilizes global positioning system (GPS) technology. Geocaching is performed as described herein with respect to FIG. 1. In FIG. 1, a cache 10 is shown. The cache 10 is made up of one or more objects, typically following a theme. For example, the objects may be stickers, coins, nature related, toy cars, sports cards, etc. The cache 10 is placed at a publicly accessible location. The cache 10 may be in plain site or hidden, as in a tree, under ground, under an object such a log, in a body of water, in a building, etc.

As part of the process, a user 12 is given coordinates that allow the user 12 to find the general location of the cache 10 by using GPS technology. The user 12 will typically have a portable GPS signal receiver 14 for processing signals 16 that are generated through a network of satellites 18 that are currently used to, among other things, assist both military and civilian navigation. This same technology is used commonly by vehicle drivers, hikers, hunters, etc.

Participants initially gain access to information regarding the location of one of many caches 10 at a preferred geographic location. While conceptually, this process could be carried out in many different ways, there currently exists a website (www.geocaching.com) that identifies a multitude of such caches and solicits participation in the “hunt”.

In one format, a user 12 that locates the cache 10 may take one or more items therefrom and replace the taken item with an item consistent with the theme.

Geocaching is particularly intriguing to those with a sense of adventure and those who like outdoor activities. Competitions are devised that often assign points based upon the severity of the terrain or structure at the location at which the cache 10 is placed. Users 12 may be required to go through streams, over densely wooded terrain, over heavily contoured terrain, etc.

According to the invention, a cache, as shown at 20 in FIG. 2, is of a nature to promote interaction, particularly with a younger audience, while potentially creating challenges and interest for virtually any user/player 12.

In its basic form, as shown schematically at 21 in FIG. 2, the inventive system utilizes the same GPS signal receiver 14 as shown in FIG. 1. The signal receiver 14 includes components that process signals 16 from the network of satellites 18 to allow the user/player 12 to program therein location coordinates, that in this case direct the user/player 12 to a zone at 22 in the vicinity of the cache 20, at a first location at which the cache 20 is placed.

With the overall system 21, as shown in FIG. 2, the following method of playing a game can be practiced, as described generically with respect to FIG. 3. As shown at block 24, a cache 20 is provided, consisting of a device shown at 26 on the system 21 in FIG. 2, through which an input can be made by a user/player 12. The device 26 is capable of generating output information, of a type described in greater detail below. As shown at block 28, the cache 20, including the device 26, are placed at a first location.

As shown at block 30, general location information is identified for a user/player 12 that will allow the user/player 12 to navigate only to the zone 22 in the vicinity of the cache 20 at the first location. In this embodiment, it is required that a user/player 12 search without the availability of precise location information for the cache 20 within the zone 22. However, the cache 20 may be clearly in view to a user/player 12 once he/she arrives at the zone 22.

The user/player 12 may navigate to the zone 22 with the assistance of a GPS signal, using a handheld, or with any other means of assistance that may or may not depend upon the processing of an electronic signal. As but one example, navigating clues may be provided online, or otherwise.

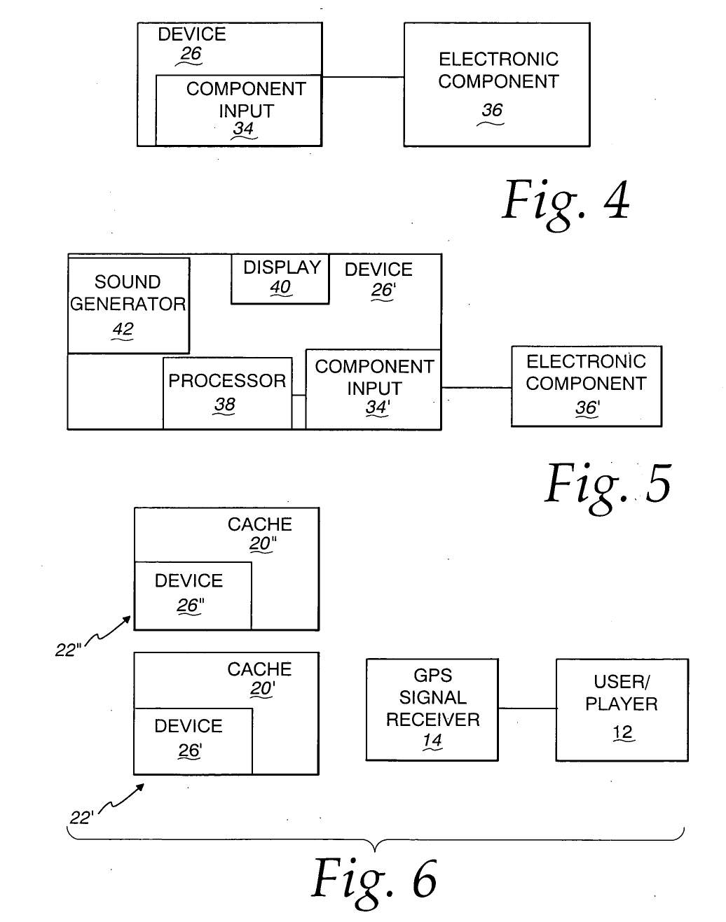

In one form, as shown in FIG. 4, the device 26 is an electronic device with a component/input 34. The component/input 34 may be nothing more than a keyboard to initiate processing in the device 26. Alternatively, the user/player 12 may be equipped with a separate electronic component 36 can be interactive with the component/input 34. The electronic component 36 may plug in to the component/input 34 or may communicate wirelessly therewith. A handheld unit is desirable for this purpose. The electronic component 36 that may have hardware and/or software that can be processed at the component/input 34 on the device 26 using any type of known communication/interaction between the component/input 34 and electronic component 36.

In one exemplary form, a device 26′, as shown in FIG. 5, is in the form of a video game with a game processor 38. As in the prior embodiment, the component/input 34′ may be a keyboard or of a design to interact with an electronic component 36′ that may incorporate compatible hardware and/or software. In one form, the electronic component 36′ may be a conventional disc that can be installed in normal fashion at the component/input 34′ to initiate operation of, or the performance of a routine or task by, the device 26′. The device 26′ may be any type of gaming device that ranges from one that merely provides or receives information, to one that is highly interactive.

In the case of a gaming device 26′, the output information may take a multitude of different forms. For example, the user/player 12 may accumulate “points” in a game primarily by accessing the device 26′. Alternatively, the user/player 12 may be required to perform a task through the electronic component 36′ that incorporates an additional challenge, be it by way of inputting specific information, performing a task that is successful or not, or performing a task graded based upon speed, dexterity, and/or skill.

As just one specific example, some video game processors are set up whereby young users/players 12 acquire and operate games associated with characters. At the device 26′ the user/player 12 may “acquire” special powers or characters.

For added appeal, the device 26′ may incorporate a visual display 40 and/or a sound generator 42, thereby making the device 26′ more appealing to all, and particularly young, users/players 12.

As shown in FIG. 3, optionally, the devices 26, 26′ may be periodically reprogrammed, as shown block 44. This adds to the appeal and/or challenge and may induce repeat visits by the user/player 12.

Alternatively, as shown in FIG. 6, multiple caches 20′, 20″ with devices 26′, 26″ may be provided at different zones 22′, 22″, at geographically spaced locations. As part of a potentially scripted game, a user/player 12 may be required, or wish, to make separate trips to the same or separate devices 26′, 26″, assisted by a GPS signal receiver 14. The device 26″ preferably generates different output information than the device 26′, which output information may be unrelated to the output information generated by the device 26′ or cumulative in nature therein.

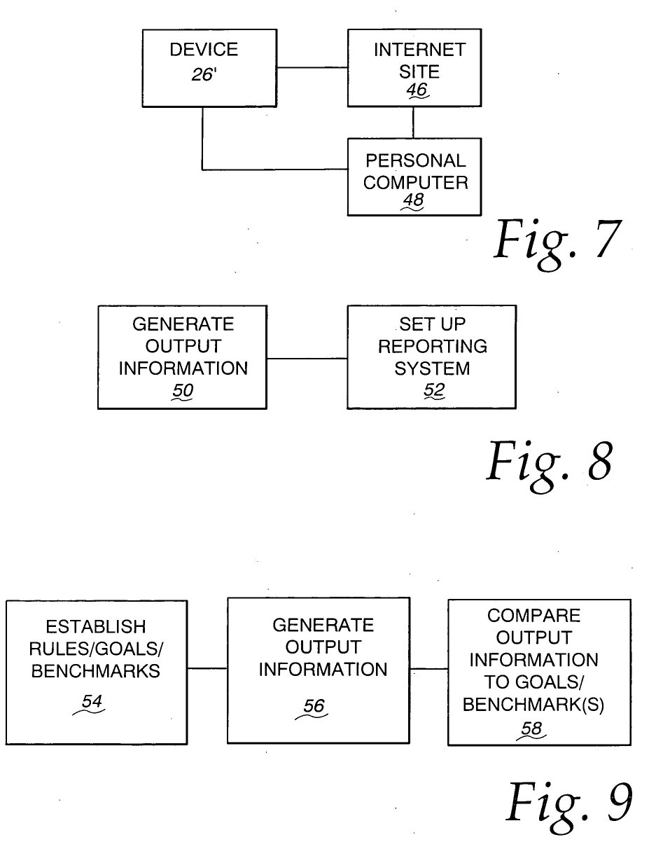

The device 26′ may be set up in a stand alone capacity. Alternatively, as shown in FIG. 7, the device 26′ may communicate, as via the Internet, to a site 46 thereon and/or to a personal computer 48 therethrough.

The configuration in FIG. 7 allows the user to generate output information, as shown at block 50 in FIG. 8, and to communicate the information so as to set up a reporting system, as shown at block 52. The reporting system 52 may allow a player to store only his/her output information for an individual challenge. Alternatively, and more preferably, output information from a particular user/player 12 can be compared and shared with output information generated by another user/player 12. Interactive competition can thus be promoted.

In one exemplary competitive format, as shown at block 54 in FIG. 9, a set of rules and/or goals is established ahead of time with potential benchmarks requiring the performance of one or more tasks. Once the output information is generated, as shown at block 56, the information is processed to compare the same to these goals/benchmarks, shown at block 58.

A single user/player 12 may generate the output information for comparison purposes. Alternatively, and preferably, multiple user/players 12 submit output information, as over the Internet, to allow comparison and competition between and amongst multiple users/players 12.

Communication may be facilitated through the cache, as through the electronic component 36 and/or component/input 34, between users/players 12 with respect to input or output information, and any other information that may contribute to the enjoyment and challenge of a competition.

The location of the cache 20 may be communicated to a user/player 12 through any means and by any method. In one form, an organizer of the game may provide cache information to users/players 12 individually and/or over the Internet, as shown at block 60 in FIG. 3. As noted above, clues may be conveyed by any means, in electronic format or otherwise. This information may be coupled with other information to promote participation, clarify rules, offer incentives and prizes, etc. This may be conveyed directly to a user/player 12 or users/players 12 and may be provided on an Internet site that may be accessed with or without special privileges. Fees may be generated in coordinating the gaming process.

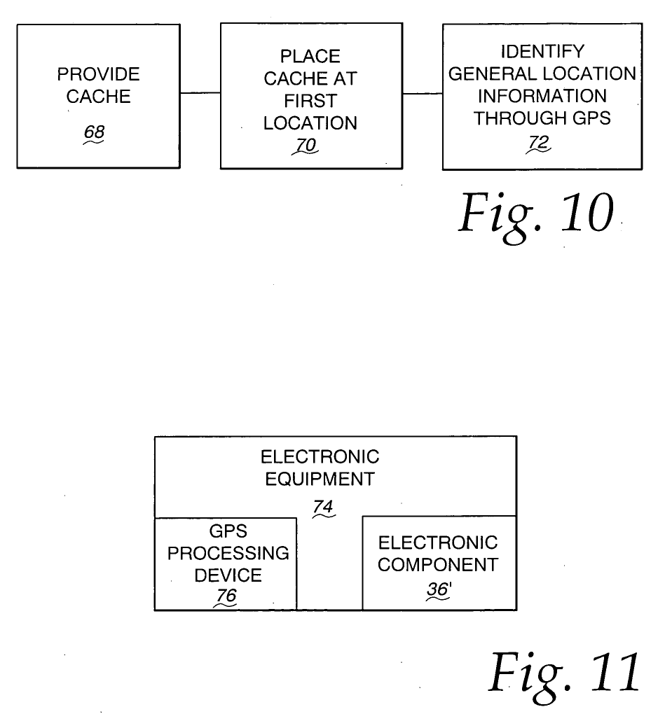

Another method of playing a game is shown in flow diagram form in FIG. 10. As shown at block 68, a cache is provided.

As shown at block 70, the cache is placed at a first location. Whereas with the method depicted in FIG. 3, the general location information can be identified by any means, with the method in FIG. 10 it is contemplated that this occurs only through use of a piece of equipment capable of processing signals from GPS satellites, as shown at block 72.

In one exemplary game, a cache 20 is placed at a first location. At the first location, the cache 20 may be visible or hidden. When hidden, the user/player 12 is required to undertake searching since he/she will only be assisted to navigate only to the zone in the vicinity of the cache 20.

The cache 20 may be placed inside a building or outside a building. The latter location lends itself to placement of impediments between the user/player 12 and the cache 20. The user/player 12 may be required to navigate through/around impediments to reach the cache 20. For example, the user/player 12 may be required to go through or over water, through wooded locations, over rolling and potentially steep terrain, etc.

The electronic component 36 may be integrated into a housing that will resist damage to the electronic and mechanical components in the event it is dropped, immersed in water, etc., as during a more challenging event around rugged terrain. The equipment may be solar powered in remote locations where power sources are not readily available, to generate power, alone or as a complement to a battery.

Alternatively, the cache 20 may be placed in a highly trafficked area such as in a public building. As one example, a store may sponsor an event to promote its wares/services.

In a modified format, a store that sells games might sponsor an event in which a user/player 12 brings in the electronic component 36, as to acquire “powers” or “characters” that are part of the theme of the competition.

To facilitate the gaming process, a portable, integrated piece of electronic equipment, as shown at 74 FIG. 11, may be provided. The electronic equipment 74 may incorporate an electronic component 36′ that is capable of producing an input to a particular device 26, 26′ 26″. The electronic equipment 74 additionally includes a GPS processing device 76 through which a signal from a global positioning system satellite can be processed, as to identify locations, addresses, coordinates, etc.

Game formats are virtually unlimited. They have in common that they require physical travel to access the caches. An exemplary game may require the performance of a single task or multiple tasks for each trip. Further, as part of a scripted game format, multiple trips may be required to the first location with multiple interactions required with the cache 20.

As shown in FIG. 6, separate caches 20′, 20″ and devices 26′, 26″ may be provided at separate locations whereby the user/player 12 is required to travel to multiple locations.

A user/player 12 may participate with the cache at the same location but get different results based upon his/her level of skill, game incentives or variations that may be purchased or earned, etc.

The invention is devised to be intriguing to all audiences and particularly to a young user/player 12 that may be intrigued by the video game aspect. This forces users/players 12 to incorporate physical activity into a gaming process using potentially conventional-type electronic gaming equipment.

Aside from requiring physical activity on the part of the user/player 12, the invention adds another element of interest to gaming of the type utilizing conventional electronic equipment and may thus offer another outlet for sales of conventional electronic equipment or equipment that might be customized to this application.

Further, a cache 20 may be provided or sponsored by an entity that uses the same to offer paid advertising, advertise its own wares/services, and/or sell its own, or others' products and/or services.

The cache 20 might be at a specific event. For example, the cache 20 may be at a venue where a sporting event is held, a concert is held, a presentation is made, etc. Virtually an unlimited type of different events might support the invention.

The user/player 12 may, at the event, be able to interact with information obtained relating to the event. Alternatively, the information may be unrelated to the event. In one format, the latter may involve downloading information, a character, a skill or power an existing player does not have, etc. That which the user/player 12 acquires is virtually unlimited in this and other formats and venues contemplated.

The invention encourages healthy group interaction and interaction with family members from an early age to an advanced age.

The foregoing disclosure of specific embodiments is intended to be illustrative of the broad concepts comprehended by the invention.

1. A method of playing a game, the method comprising the steps of:
providing a cache comprising a device through which an input can be made by a player to generate output information for a player;
placing the cache at a first location; and
identifying for a player general location information that will allow a player to navigate to a zone in the vicinity of the cache at the first location but that requires a player to search without the availability of precise location information within the zone to find the cache.

2. The method of playing a game according to claim 1 further comprising the step of providing cache information to a player regarding the output information to entice a player to participate in the game.

3. The method of playing a game according to claim 1 wherein the step of providing a cache comprises providing a cache comprising an electronic device.

4. The method of playing a game according to claim 1 wherein the step of identifying general location information comprises identifying general location information from data that can be input to a piece of equipment capable of processing signals from global positioning system satellites to allow a player to navigate to the zone.

5. The method of playing a game according to claim 1 wherein the step of placing the cache comprises placing the cache at a first hidden location.

6. The method of playing a game according to claim 1 wherein the step of placing the cache comprises placing the cache at a first location that requires a player to navigate through/around impediments to reach the cache.

7. The method of playing a game according to claim 1 wherein the step of placing the cache comprises placing the cache at a first location that is outside of a building structure.

8. The method of playing a game according to claim 2 wherein the step of providing a cache comprises providing a cache comprising a device comprising a first electronic component.

9. The method of playing a game according to claim 8 further comprising the step of providing at least a second electronic component that is usable with the first electronic component.

10. The method of playing a game according to claim 9 wherein the step of providing a cache comprises providing a first electronic component comprising a processor that interacts with the second electronic component to generate the output information.

11. The method of playing a game according to claim 10 wherein the step of providing a cache comprises providing a first electronic component comprising a game processor.

12. The method of playing a game according to claim 1 further comprising the steps of at least one of: a) repositioning the electronic device from the first location; or b) providing a different electronic device to change the output information that can be generated by a player.

13. The method of playing a game according to claim 1 further comprising the step of setting up a reporting system whereby a player can store output information.

14. The method of playing a game according to claim 1 further comprising the step of setting up a reporting system whereby a player can compare output information with at least one of: a) output information generated by him/herself; and b) output information generated by another player.

15. The method of playing a game according to claim 4 further comprising the step of providing a piece of electronic equipment for use by a player, with the piece of electronic equipment comprising a combination of: a) an electronic component that can be processed by the device; and b): a global positioning system device through which signals from global positioning system satellites can be processed.

16. The method of playing a game according to claim 1 wherein the step of identifying for a player general information comprises identifying general information on an Internet site.

17. The method of playing a game according to claim 1 further comprising the step of setting up at least one of: a) a set of rules; and b) a set of goals on an Internet site to allow competition with additional players.

18. The method of playing a game according to claim 17 wherein the step of setting up of at least one of a set of rules and a set of goals comprises setting up at least one of a set of rules and a set of goals that have benchmarks requiring the performance of multiple tasks.

19. The method of playing a game according to claim 17 wherein the step of setting up of at least one of a set of rules and a set of goals comprises setting up at least one of a set of rules and a set of goals that have benchmarks requiring the performance of multiple tasks comprising at least one of: a) multiple trips to the first location and multiple interactions with the cache; and b) at least a second trip to at least one of: i) the first location; and ii) a second location at which a second cache is located and multiple interactions with the cache at the first location and/or second location.

20. The method of playing a game according to claim 17 wherein the step of providing a cache comprises providing a cache comprising a device comprising a first electronic component with a video display.

21. A method of playing a game, the method comprising the steps of:
providing a cache comprising a device through which an input can be made by a player to generate output information for a player;
placing the cache at a first location; and
identifying for a player general location information that will allow a player to navigate to a zone in the vicinity of the cache at the first location using only data that can be input to a piece of equipment capable of processing signals from a global positioning system satellite.

22. The method of playing a game according to claim 21 wherein the step of providing a cache comprises providing a cache comprising an electronic device.

23. The method of playing a game according to claim 22 wherein the step of providing a cache comprises providing a cache comprising a device comprising a first electronic component.

24. The method of playing a game according to claim 23 further comprising the step of providing at least a second electronic component that is usable with the first electronic component.

25. The method of playing a game according to claim 24 wherein the step of providing a cache comprises providing a first electronic component comprising a processor that interacts with the second electronic component to generate the output information.
